(19) United States
(12) Patent Application Publication
(10) Pub. No.: US 2015/0239048 A1
(43) Pub. Date: Aug. 27, 2015

(54) MANUFACTURING METHOD OF RARE EARTH MAGNET ALLOY POWDER, RARE EARTH MAGNET AND A POWDER MAKING DEVICE

(71) Applicant: XIAMEN TUNGSTEN CO., LTD., Xiamen, Fujian (CN)

(72) Inventors: Hiroshi Nagata, Xiamen (CN); Chonghu Wu, Xiamen (CN)

(73) Assignee: XIAMEN TUNGSTEN CO., LTD., Xiamen, Fujian (CN)

(21) Appl. No.: 14/427,159

(22) PCT Filed: Sep. 10, 2013
(86) PCT No.: PCT/CN2013/083238

§ 371 Date: Mar. 10, 2015

(30) Foreign Application Priority Data
Sep. 12, 2012 (CN) 201210336861.8
Sep. 12, 2012 (CN) 201210339562.X

(51) Int. Cl. B22F 9/04; H01F 1/053; H01F 41/02

(52) U.S. Cl. CPC B22F 9/04; H01F 41/0266; H01F 1/0536; B22F 2009/044

(57) ABSTRACT

The present invention discloses a manufacturing method and device of rare earth magnet alloy powder and rare earth magnet. The method comprises a process of fine grinding at least one kind of rare earth magnet alloy or at least one kind of rare earth magnet alloy coarse powder in inert jet stream with oxygen content below 1000 ppm to obtain powder with grain size smaller than 50 μm. Low oxygen content ultra fine powder with grain size smaller than 1 μm is not separated from the pulverizer, the oxygen content of the atmosphere is reduced to below 1000 ppm in the pulverizer when crushing the powder, thereby abnormal grain growth (AGG) rarely happens in the sintering process to get low oxygen content sintered magnet, it has advantages of simplifying process and reducing manufacturing cost.

### FIELD OF THE INVENTION

The present invention relates to magnet manufacturing field, especially to manufacturing method of rare earth magnet alloy powder, rare earth magnet and powder making device of rare earth magnet alloy powder.

### BACKGROUND OF THE INVENTION

Rare earth magnet is based on intermetallic compound R₂T₁₄B, thereinto, R is rare earth element, T is iron or transition metal element to replace iron or part of iron, B is boron, it is known as king of the magnet with excellent magnetic properties, the max magnetic energy product (BH)max is ten times higher than that of the ferrite magnet (Ferrite), besides, the rare earth magnet has well machining property, the operation temperature can reach 200° C., it is hard, stable, with well cost performance and wide applicability. There are two types rare earth magnets depending on the manufacturing method: sintered magnet and bonded magnet. Sintered magnet has wider applications. In existing known technology, sintering method of rare earth magnet is normally performed as follows: raw material preparing→melting→casting→hydrogen decrepitation→micro grinding→pressing under magnetic field→sintering→heat treatment→magnetic property evaluation→oxygen content evaluation of the sintered magnet.

In the manufacturing method of rare earth magnet, the powder making process is usually applied with jet mill method as micro grinding of the rare earth magnet. It is generally believed that it is appropriate to classify and remove the oxidized R rich ultra fine powder (smaller than lulu) that is 0.3˜3% of the production by using jet milling method. This R rich ultra fine powder is easier to be oxidized compared to other powder with less rare earth element R content (with larger grain size). The rare earth element will be oxidized significantly if the R rich ultra fine powder is not removed in sintering process, which leads to consummation of rare earth element R combined with oxygen, resulting in lowering production of main R₂T₁₄B crystal phase.

FIG. 1 is a powder making device applied with jet milling method, the oxygen content in the gas atmosphere is about 10000 ppm during the crushing process. The device comprises a pulverizer 1′, a classification device 2′, a powder collecting device 3′, a ultra fine powder collecting device 4′ and a compressor 5′, the pulverizer 1′ is disposed with a filter 11′. The filter 11′ is connected to the air outlet of the pulverizer 1′, the air inlet of the pulverizer 1′ is connected to the compressor 5′ via pipe, the air outlet of the pulverizer 1′ is connected to the classification device 2′ via pipe, the classification device 2′ is connected to the powder collecting device 3′ and the ultra fine powder collecting device 4′ respectively. In the powder making process, the coarse powder (so as raw material) is put into the pulverizer 1′ through the raw material inlet, the coarse powder (raw material) is crushed by jet mill method in the pulverizer 1′, powder with grain size smaller than the target grain size is delivered to the classification device 2′ via pipe for classification with the filtering of the filter 11′, the uncrushed powder or imperfect crushed powder are kept in the pulverizer 1′ for further jet mill crushing; in the classification device 2′, by classification process, the ultra fine powder enters the ultra fine powder collecting device 4′ via pipe after a classification process, the final powder entered the powder collecting device 3′ for subsequent process; the gas and the ultra fine powder are separated in the ultra fine powder collecting device 4′, air outlet of the ultra fine powder device 4′ is connected to the compressor 5′ via pipe, the gas recycles via compressor 5′, ultra fine powder is kept in the ultra fine powder collecting device 4′. in this powder making process, The ultra fine powder collected by the ultra fine powder collecting device 4′ is usually threw away in this powder making process. The oxygen content of the sintered magnet obtained from above method is around 2900 ppm˜5300 ppm.

On the other hand, oxidant rarely happens in the forming and sintering process with the development of anti-oxidant techniques. Thus the oxygen content of the magnet is mainly depending on the jet mill process in the large tonnage of gas. High performance sintered magnet with oxygen content reducing to below 2500 ppm can be obtained when the oxygen content in the jet mill is reduced to lower than 1000 ppm. However, oversintering may happen in the sintering process with low oxygen content which leads to abnormal grain growth (AGG) problem. Problem of low coercivity, poor squareness and heat resistance will be more significant. 0.5%˜1% weight of Ga, Zr, Mo, V, W, etc is usually added to prevent abnormal grain growth, but these elements are non-magnetic elements, which not only makes the process complicated and high costly but also leads to low Br, (BH)max of the magnet.

### SUMMARY OF THE INVENTION

The object of the present invention is to overcome the disadvantages of the existing known technology and provide a manufacturing method of rare earth magnet alloy powder, without the separation of low oxygen content ultra fine powder with grain size smaller than 1 μm from the pulverizer, the oxygen content of the atmosphere is reduced to below 1000 ppm in the pulverizer when crushing the powder, so that abnormal grain growth (AGG) rarely happens in the sintering process to get low oxygen content sintered magnet, it has advantages of simplifying process and reducing manufacturing cost.

The technical proposal of the present invention is as follows:

A manufacturing method of rare earth magnet alloy powder, the rare earth magnet comprises R₂T₁₄B main phase, R is at least one kind of rare earth elements comprising yttrium, T is at least one kind of transition metal elements comprising Fe and/or Co, wherein the method comprises a process of fine grinding at least one kind of rare earth magnet alloy or at least one kind of rare earth magnet alloy coarse powder in inert jet stream with oxygen content below 1000 ppm to obtain powder that has grain size smaller than 50 μm, the powder comprised ultrafine powder with grain size smaller than 1 μm.

The present invention no longer separate and discard the ultra fine powder (with grain size smaller than 1 μm) from the low oxygen content powder, the total oxygen content of the powder is 1000˜2000 ppm by adjusting the oxygen content of the inert jet steam, so that abnormal grain growth (AGG) rarely happens in the sintering process to get low oxygen content sintered magnet. The coercivity is not reduced with about 40° C. of variability in the sintering temperature. In the performance aspect: compared to the sintered magnet formed from the powder separating the ultra fine powder, the coercivity can be increased 12%, squareness can be increased maximum 15%, it can also save valuable rare earth, thus contributing to the pricing.

The un-separated ultra fine powder in the present invention means that the total powder of jet mill used in the subsequent process. The total powder is almost all powder with ultra fine powder to make magnet product except some rest powder (a small amount of powder rest in the pulverizer, classifying roller, pipe, compressor, pressure container, connector of valve and the powder container, sample powder for analyzing, forming test and QC). It also means that the ultra fine powder is separated and discarded in the existing technology but effectively used in the present invention.

The grain size is the grain size of each particle. smaller than 50 μm means the grain size of each particle doesn't exceed 50 μm. In other words, it is a crystal grain group with maximum grain size smaller than 50 μm (it also contains ultra fine powder with grain size smaller than 1 μm).

Magnet with ultra fine powder is made by jet milling with different crystal grain, and then magnetic performance experiments are performed many times, the maxim grain size is set as 50 μm as the result. The preferred powder grain size is below 30 μm, more preferably below 20 μm.

With nuclear generating type coercivity mechanism, defects on the surface of each grain frequently occurs in the sintered rare earth magnet when the grain size of the crystal grain increases. Generally speaking, it will make the deficiency repair performance by R rich phase in the sintering process less efficient, the coercivity and squareness decrease rapidly. Hence, existing of large grain with grain size larger than 50 μm leads to decrease of coercivity and squareness of the sintered magnet.

The powder grain size evaluation is to determine the diameter of the equal ball to the powder in the microscope. The reason is that in applying laser reflecting method to characterize, a small amount of largest grain is ignored and failed to be found in statistic process. Besides, gas permeability method like FSSS can obtain average grain size by probability calculation but the grain size of the largest grain can not be obtained.

The rare earth magnet of the present invention contains necessary elements like R, T, B to form R₂T₁₄B main phase, it also contains 0.01 at %˜10 at % dopant element M, M can be at least one kind of Al, Ga, Ca, Sr, Si, Sn, Ge, Ti, Bi, C, S or P.

The flow rate of the inert jet stream is 2˜50 m/s.

The normal temperature dew point of the inert jet stream is below −10° C. in 0.1 MPa˜1.0 MPa.

In another preferred embodiment, the rare earth magnet alloy comprises at least two kinds of rare earth magnet alloy with different rare earth components and/or contents.

In another preferred embodiment, the alloy coarse powder is obtained from alloy by using hydrogen decrepitation method.

In another preferred embodiment, the rare earth magnet alloy is obtained from alloy melt liquid by strip casted and cooled in a cooling speed between 10²° C./s and 10⁴° C./s.

Another object of the present invention is to provide a manufacturing method of rare earth magnet

The technical proposal of the present invention is as follows:

A manufacturing method of rare earth magnet, the rare earth magnet comprises R₂T₁₄B main phase, R is at least one kind of rare earth elements comprising yttrium, T is at least one kind of transition metal elements comprising Fe and/or Co, wherein comprising following processes:
fine grinding at least one kind of rare earth magnet alloy or at least one kind of rare earth magnet alloy coarse powder in inert jet stream with oxygen content below 1000 ppm to obtain powder that has grain size smaller than 50 μm, the powder comprises ultrafine powder with grain size smaller than 1 μm; and
compact is produced by compacting the aforementioned powder;
sintering the green compacts to make rare earth magnet.

Another object of the present invention is to provide a powder making device of rare earth magnet alloy powder.

The technical proposal of the present invention is as follows:

A powder making device of rare earth magnet alloy powder, comprising a pulverizer, a first collecting device, a charging bucket and a compressor, the pulverizer comprises a powder inlet, an air inlet at the lower portion and an air outlet at the upper portion, the air inlet of the pulverizer is connected to the compressor, the air outlet is disposed with a first filter for powder with grain size smaller than 50 μm; the first collecting device is disposed with an air inlet at the upper portion and an air outlet at the top portion, the air inlet is connected to the air outlet of the pulverizer by a pipe, the bottom of the first collecting device is connected to the charging bucket, wherein the air outlet of the first collecting device is extending downwardly with a second filter for gas-solid separation, and is connected to the compressor, the second filter is disposed corresponding to the air inlet of the first collecting device.

The powder making device is applied with a filter for gas-solid separation in the first collecting device, so that the easy oxidant ultra fine powder is not separated in the first collecting device but mixed to the finished powder to be collected by the first collecting device.

Another technical proposal of the present invention is as follows:

A powder making device of rare earth magnet alloy powder, comprising a pulverizer, a first collecting device, a charging bucket, a second collecting device and a compressor, the pulverizer comprises a powder inlet, an air inlet at the lower portion and an air outlet at the upper portion, the air inlet of the pulverizer is connected to the compressor, the air outlet is disposed with a filter for powder with grain size smaller than 50 μm; the first collecting device is disposed with an air inlet at the upper portion and an air outlet at the top portion, the air inlet is connected to the air outlet of the pulverizer via pipe, the bottom of the first collecting device is connected to the charging bucket, the second collecting device is ultra fine powder collecting device with an air inlet at the upper portion and an air outlet at the top portion, the air inlet is connected to the air outlet of the first collecting device via pipe, the air outlet is connected to the compressor, the ultra fine powder is powder with grain size smaller than 1 μm, the second collecting device is disposed with a powder outlet at the bottom portion, the powder outlet is connected to the bottom portion of the first collecting device via a pipe with a valve.

Compared to the existing technology, the present invention has following advantages:
1) By mixing the rare earth rich ultra fine powder that is discarded before, the present invention has advantages of saving valuable rare earth and reducing cost.
2) As the oxygen content of the inert jet stream in the JM process is below 1000 ppm, oxidization rarely happens in the rare earth element of the ultra fine powder and the effective impurity, the ultra fine powder can severe as sintering assistant, it can also reduce the possibility of abnormal grain growth (AGG) in the sintering process, hence improving the coercivity and the squareness, it also simplifies the process and reduces the manufacturing cost.
3) The ultra fine powder contains oxygen, thus making it stable, and it contains much effective impurity like Si, Cu, Cr, Mn, S, P, etc, so that the sintered magnet made from the powder with ultra fine powder has high corrosion resistance, the corrosion resistance is improved even without Co, saving high cost and valuable Co.
4) the ultra fine powder collecting device becomes unnecessary, so that the device is simple, it prevents sever problems like ultra fine powder burning, device burning, or personal burn when cleaning the device.

### BRIEF DESCRIPTION OF THE DRAWINGS

FIG. 1 illustrates a schematic diagram of the existing jet milling apparatus.

FIG. 2 illustrates a schematic diagram of the jet milling apparatus in the embodiments 1-3 and the comparing examples 1-6.

FIG. 3 illustrates a schematic diagram of the jet milling apparatus in the embodiments 4-6 and the comparing examples 7-12.

### DETAILED DESCRIPTION OF THE EMBODIMENTS

The present invention will be further described with the embodiments, but it should be noted that it is not a limitation to the scope of the invention.

### Embodiments 1-3

The present invention takes NdFeB rare earth alloy magnetic powder for example to illustrate the manufacturing process and evaluation process of the rare earth magnet. The manufacturing process includes following manufacturing processes: raw material preparing→melting→casting→hydrogen decrepitation→micro grinding→pressing under magnetic field→sintering→heat treatment→magnetic property evaluation→oxygen content evaluation of the sintered magnet.

In the raw material preparing process: Nd with 99.5% purity, industrial Fe—B, industrial pure Fe are prepared, the weight ratio of the components is shown in TABLE 1.

TABLE 1
The weight ratio of the components

| No. | Nd | Fe | B |
|---|---|---|---|
| Embodiment 1 | 28 | 71 | 1 |
| Embodiment 2 | 30 | 69 | 1 |
| Embodiment 3 | 33 | 66 | 1 |

Based on above weight ratio of embodiments 1-3, 10 Kg raw materials are prepared respectively.

In melting process: the prepared raw materials are put into a crucible made of aluminum oxide, a intermediate frequency vacuum induction melting furnace is used to melt the raw materials to 1500° C. in a 10⁻² Pa vacuum.

In casting process: Ar gas is filled to the melting furnace to 10000 Pa after vacuum melting, thencentrifugal casting method is used to cast in order to get rapid cooling alloy in a cooling rate of 1000° C./s.

In hydrogen decrepitation process: the crushing room with rapid cooling alloy is pumped at room temperature, then filling with hydrogen with 99.5% purity to 0.1 Mpa, leave for 2 hours, after that, heating the crushing room and pumping at the same time, then keeping vacuum in 300° C. for 2 hours, the crushed specimen with average grain size between 200 μm˜1000 μm is taken out after cooling.

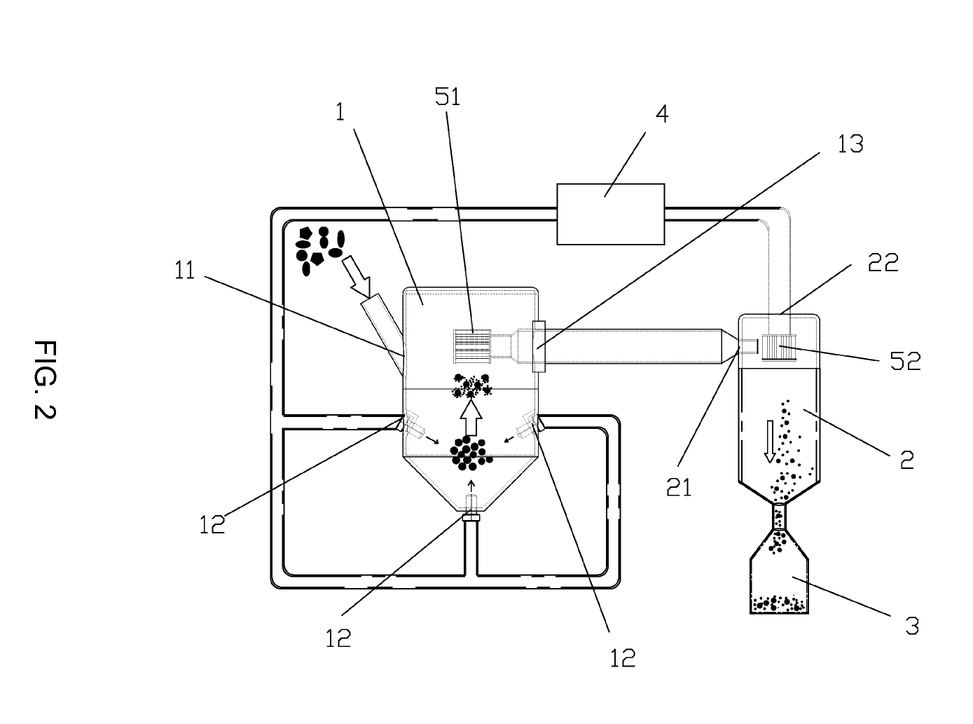

In micro grinding process: the powder making device in this process is shown in FIG. 2, the device comprises a pulverizer 1, a first collecting device 2, a charging bucket 3 and a compressor 4; the pulverizer 1 comprises a powder inlet 11, an air inlet 12 at the lower portion and an air outlet 13 at the upper portion; the air inlet 12 of the pulverizer 1 is connected to the compressor 4, the air outlet 13 is disposed with a first filter 51 for powder with grain size smaller than 50 μm; the first collecting device 2 is disposed with an air inlet 21 at the upper portion and an air outlet 22 at the top portion, the air inlet 21 is connected to the air outlet 13 of the pulverizer 1 by a pipe, the bottom of the first collecting device 2 is connected to the charging bucket 3; the air outlet 22 of the first collecting device 2 is extending downwardly with a second filter 52 for gas-solid separation, and is connected to the compressor 4; the second filter 52 is disposed corresponding to the air inlet 21 of the first collecting device.

The powder after hydrogen decrepitation is put into the pulverizer 1 from the powder inlet 11, when the compressor 4 works, inert gases recycles in the compressor 4 with the oxygen content lower than 100 ppm, dew point is −38° C. (normal temperature 0.4 MPa), flow rate is 5 m/s, airflow enters the pulverizer 1 through the air inlet 12, the raw material is jet milled in a condition that the pressure of the pulverizer is 0.4 MPa, under the work of the airflow, the grinded powder with grain size smaller than 50 μm enters the first collecting device 2 through the first filter 51 disposed at the air outlet 13 at the upper portion, uncrushed or imperfect crushed powder (with grain size larger than needed) are kept in the pulverizer 1 for further jet mill crushing; airflow with crushed powder enters the first collecting device 2, at this time, large powder drops down due to gravity, ultra fine powder enters the air outlet 22 of the first collecting device 2 with the airflow, but it can pass through the second filter 52, it is also kept in the first collecting filter 2, and is then collected to the charging bucket 3 with the large powder. The airflow passing through the second filter 52 enters the compressor 4 for recycle.

To prevent blockage of the first filter 51 and the second filter 52, there are shaking machines disposed respectively in the first filter 51 and the second filter 52 for shaking. The crushed powder is added with molding promoter that is sold in the market as forming assistant, in the present invention, the molding promoter is methyl caprylate, the additive amount is 0.2% of the rare earth alloy magnetic powder, the mixture is well blended by V-type mixer.

In pressing under magnetic field process: using a right orientation type magnetic field molding, in a relative humidity of 1˜3%, the powder is then compacted to a cube with edge 40 mm in an 2.0 T of orientation filed and 0.8 ton/cm² of forming pressure, then the cubes are demagnetized in 0.2 T magnetic filed.

It is compacted in argon atmosphere, the oxygen content stays below 1000 ppm, the forming machine is configured with humidifier and cooling device, it is compacted in a temperature of 25° C.

In the sintering process: the compacts are moved to the sintering furnace to sinter, in a vacuum of 10⁻¹ Pa for 2 hours in 200° C. and for 2 hours in 900° C., then sintering for 2 hours in 1050° C., after that filling in Ar gas to 0.1 MPa, cooling to room temperature.

In the heating process, the sintered magnet is heated for 1 hour in 580° C. in high purity Ar gas, then cooling it to room temperature and taking it out.

In magnetic property evaluation process: the sintered magnet is tested by NIM-10000H nondestructive testing of large rare earth permanent magnet of China metrology institute, the testing temperature is 20° C.

In the oxygen content of sintered magnet evaluation process: the oxygen content of the sintered magnet is measured by EMGA-620W oxygen and nitrogen analyzer of Japan HORIBA company.

In the corrosion resistance performance experiment: using a precision electronic balance to evaluate the weightlessness value (mg) of the sintered magnet for 20 days after HSAT (IEC68-2-66) experiment.

### Comparing Samples 1-6

The difference of the comparing samples 1-6 from the embodiment 1-3 is that:

In the raw material preparing process:
Nd with 99.5% purity, industrial Fe—B, industrial pure Fe and Co with 99.9% purity are prepared, the weight ratio of the components is shown in TABLE 2.

TABLE 2
The weight ratio of the components

| No. | Nd | Fe | B | Co |
|---|---|---|---|---|
| Comparing | 28 | 71 | 1 | 0 |
| sample 1 | | | | |
| Comparing | 30 | 69 | 1 | 0 |
| sample 2 | | | | |
| Comparing | 33 | 66 | 1 | 0 |
| sample 3 | | | | |
| Comparing | 28 | 69 | 1 | 2 |
| sample 4 | | | | |
| Comparing | 30 | 67 | 1 | 2 |
| sample 5 | | | | |
| Comparing | 33 | 64 | 1 | 2 |
| sample 6 | | | | |

Based on above weight ratio of comparing samples 1-6, 10 Kg raw materials are respectively prepared.

In the micro grinding process:

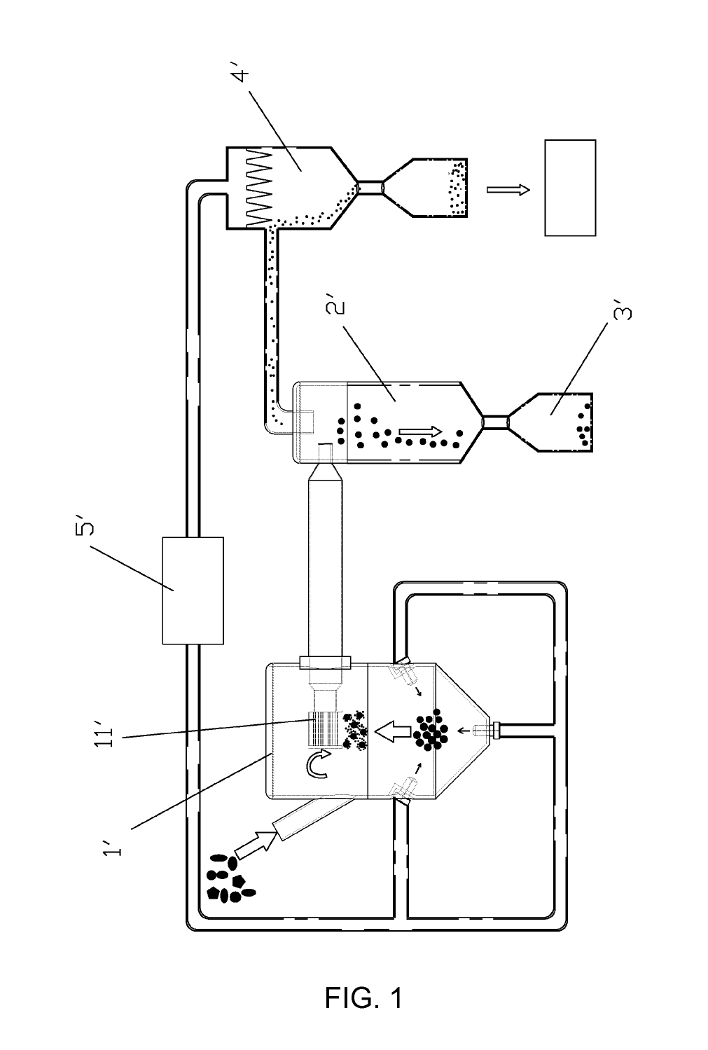

The powder making device in the micro grinding process is figured in FIG. 1, the device comprises a pulverizer 1′, a classification device 2′, a powder collecting device 3′, a ultra fine powder collecting device 4′ and a compressor 5′; the pulverizer 1′ is disposed with a filter 11′ for powder with grain size smaller than 20 μm. The filter 11′ is connected to the air outlet of the pulverizer 1′, the air inlet of the pulverizer 1′ is connected to the compressor 5′ via pipe, the air outlet of the pulverizer 1′ is connected to the classification device 2′ via pipe, the classification device 2′ is connected to the powder collecting device 3′ and the ultra fine powder collecting device 4′ respectively. In the powder making process, the coarse powder (so as raw material) is put into the pulverizer 1′ through the raw material inlet, the compressor 5′ works with cycling air, air enters the pulverizer 1′ from the air inlet of the pulverizer 1′, in an inert jet steam with oxygen content below 1000 ppm, dew point −38° C. (normal temperature, 0.4 MPa), flow rate 5 m/s, the pressure of the pulverizer is 0.4 MPa, the raw material is jet milled, powder with grain size smaller than 50 μm enters the classification devices 2′ for classification through the first filter 11′ disposed at the air outlet of the pulverizer at the upper portion under the work of the airflow, the uncrushed powder or imperfect crushed powder are kept in the pulverizer 1′ for further jet mill crushing; in the classification device 2′, by classification process, the ultra fine powder enters the ultra fine powder collecting device 4′ via pipe, the finished powder enters the powder collecting device 3′ for subsequent process; in the ultra fine powder collecting device 4′, the gas and the ultra fine powder are separated, air outlet of the ultra fine powder device 4′ is connected to the compressor 5′ via pipe, the gas recycles via compressor 5′, the ultra fine powder is kept in the ultra fine powder collecting device 4′, it should be noted that, the ultra fine powder is powder with grain size smaller than 1 μm, the ultra fine powder collected by the ultra fine powder collecting device 4′ is discarded. Discard rate of ultra fine powder (%): calculating the powder weight of the ultra fine powder collecting device 4′, divided by the raw material weight, expressed as a percentage.

TABLE 3 is a magnetic property comparison TABLE between the embodiments and the comparing samples.

TABLE 3
magnetic property comparison TABLE

| | Discard | | | | | | Oxygen |
|---|---|---|---|---|---|---|---|
| | rate of | | | | | | Content of |
| | ultra fine | | | | (BH) | HAST | the Sintered |
| | powder | Br | Hcj | Hk/Hcj | max | weightlessness | magnet |
| No. | (%) | (kGs) | (k0e) | (%) | (MG0e) | (mg) | (ppm) |
| Embodiment 1 | 0 | 14.6 | 12.3 | 97.8 | 51.4 | 1.8 | 920 |
| Embodiment 2 | 0 | 13.8 | 15.2 | 97.9 | 46.6 | 1.8 | 965 |
| Embodiment 3 | 0 | 13.3 | 17.3 | 98.2 | 43.7 | 1.9 | 981 |
| Comparing | 0.9 | 14.5 | 11.3 | 86.5 | 50.2 | 25.2 | 865 |
| sample 1 | | | | | | | |
| Comparing | 1.2 | 13.7 | 14.2 | 87.5 | 45.1 | 28.5 | 873 |
| sample 2 | | | | | | | |
| Comparing | 3.2 | 13.2 | 16.5 | 88.3 | 42.1 | 32.6 | 883 |
| sample 3 | | | | | | | |
| Comparing | 2.1 | 14.5 | 10.2 | 78.5 | 50.4 | 6.2 | 913 |
| sample 4 | | | | | | | |
| Comparing | 2.8 | 13.7 | 13.1 | 79.2 | 45.1 | 7.5 | 925 |
| sample 5 | | | | | | | |
| Comparing | 3.9 | 13.2 | 15.3 | 78.9 | 42.2 | 8.9 | 940 |
| sample 6 | | | | | | | |

### Embodiments 4-6

The difference of the embodiments 4-6 from the embodiments 1-3 is that:

In the raw material preparing process: Nd with 99.5% purity, industrial Fe—B, industrial pure Fe are prepared, the weight ratio of the components is shown in TABLE 4.

TABLE 4
The weight ratio of the components

| No. | Nd | Fe | B |
|---|---|---|---|
| Embodiment4 | 28 | 71 | 1 |
| Embodiment5 | 30 | 69 | 1 |
| Embodiment6 | 33 | 66 | 1 |

Based on above weight ratio of embodiments 4-6, 10 Kg raw materials are respectively prepared.

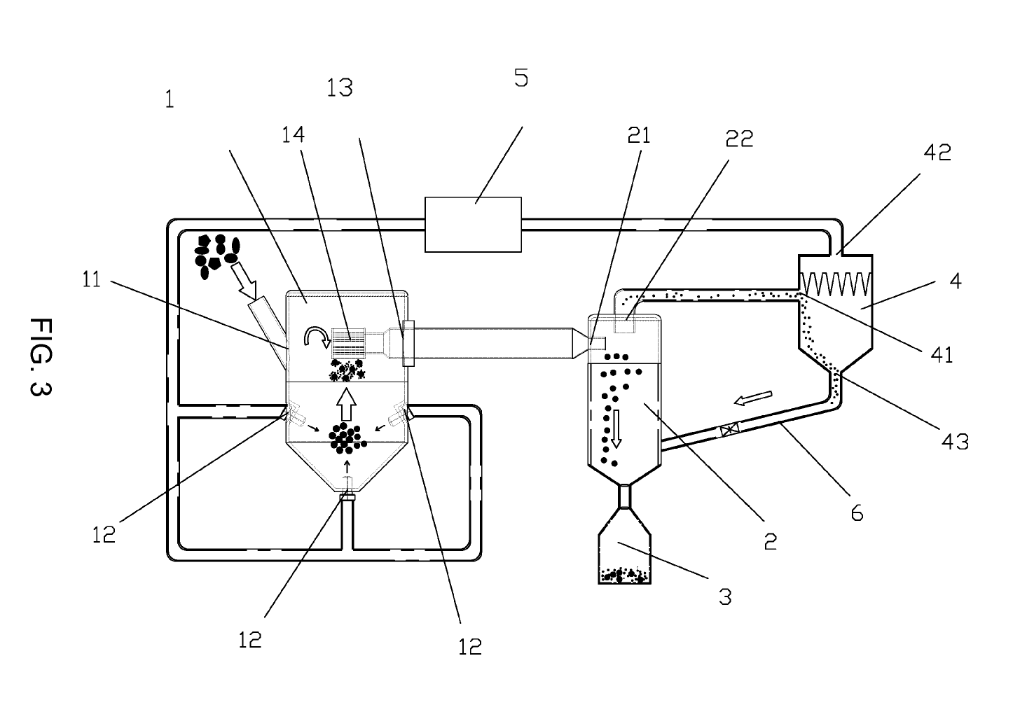

The powder making device in this micro grinding process is shown in FIG. 3 that the device comprises a pulverizer 1, a first collecting device 2, a charging bucket 3, a second collecting device 4 and a compressor 5; the pulverizer 1 comprises a powder inlet 11, an air inlet 12 at the lower portion and an air outlet 13 at the upper portion, the air inlet 12 of the pulverizer 1 is connected to the compressor 5, the air outlet 13 is disposed with a first filter 14 for powder with grain size smaller than 20 μm; the first collecting device 2 is disposed with an air inlet 21 at the upper portion and an air outlet 22 at the top portion, the air inlet 21 is connected to the air outlet 13 of the pulverizer 1 via pipe, the bottom of the first collecting device 2 is connected to the charging bucket 3, the second collecting device 4 is ultra fine powder collecting device, it is disposed with an air inlet 41 at the upper portion and an air outlet at the top portion, the air inlet 41 is connected to the air outlet 22 of the first collecting device 2, the air outlet 42 is connected to the compressor 5, the second collecting device 4 is disposed with a powder outlet 43 at the bottom, the powder outlet 43 is connected to the bottom of the first collecting device 2 via pipe with valve.

The powder after hydrogen decrepitation is put into the pulverizer 1 from the powder inlet 11, when the compressor 5 works, inert gases recycles in the compressor 4 with the oxygen content between 500 ppm˜1000 ppm, dew point is −10° C. (normal temperature 1.0 MPa), flow rate is 50 m/s, with the pressure of the pulverizer 1.0 Mpa, under the work of the airflow, the grinded powder with grain size smaller than 20 μm enters the first collecting device 2 through the filter 14 disposed at the air outlet 13 at the upper portion, uncrushed or imperfect crushed powder (with grain size larger than needed) are kept in the pulverizer 1 for further jet mill crushing; airflow with crushed powder enters the first collecting device 2, at this time, large powder drops down due to gravity, ultra fine powder enters the air outlet 22 of the first collecting device 2 with the airflow, and then entering the second collecting device 4, in the second collecting device, ultra fine powder is collected and entered the bottom of the first collecting device 2 via powder outlet 43, mixed with the large powder collected in the first collecting device 2, the powder then enters the charging bucket 3. The airflow passing through the second collecting device 4 flows to the compressor 5 for recycle.

### Comparing Samples 7-12

The difference of the comparing samples 7-12 from the comparing samples 1-6 is that:

In the raw material preparing process:
Nd with 99.5% purity, industrial Fe—B, industrial pure Fe and Co with 99.9% purity are prepared, the weight ratio of the components is shown in TABLE 5.

TABLE 5
The weight ratio of the components

| No. | Nd | Fe | B | Co |
|---|---|---|---|---|
| Comparing | 28 | 71 | 1 | 0 |
| sample 7 | | | | |
| Comparing | 30 | 69 | 1 | 0 |
| sample 8 | | | | |
| Comparing | 33 | 66 | 1 | 0 |
| sample 9 | | | | |
| Comparing | 28 | 69 | 1 | 2 |
| sample 10 | | | | |
| Comparing | 30 | 67 | 1 | 2 |
| sample 11 | | | | |
| Comparing | 33 | 64 | 1 | 2 |
| sample 12 | | | | |

Based on above weight ratio of comparing samples 7-12, 10 Kg raw materials are respectively prepared.

In the micro grinding process: The powder making device in the micro grinding process is shown in FIG. 1, the device comprises a pulverizer 1′, a classification device 2′, a powder collecting device 3′, a ultra fine powder collecting device 4′ and a compressor 5′; the pulverizer 1′ is disposed with a filter 11′ for powder with grain size smaller than 20 μm. The filter 11′ is connected to the air outlet of the pulverizer 1′, the air inlet of the pulverizer 1′ is connected to the compressor 5′ via pipe, the air outlet of the pulverizer 1′ is connected to the classification device 2′ via pipe, the classification device 2′ is connected to the powder collecting device 3′ and the ultra fine powder collecting device 4′ respectively. In the powder making process, the coarse powder (so as raw material) is put into the pulverizer 1′ through the raw material inlet, the compressor 5′ works with cycling air, air enters the pulverizer 1′ from the air inlet of the pulverizer 1′, in an inert jet steam of oxygen content 500 pp,˜1000 ppm, dew point −10° C. (normal temperature, 1.0 MPa), flow rate 5 m/s, the pressure of the pulverizer is 1.0 MPa, the raw material is jet milled, powder with grain size smaller than 20 μm enters the classification devices 2′ for classification through the first filter 11′ disposed at the air outlet of the pulverizer at the upper portion under the work of the airflow, the uncrushed powder or imperfect crushed powder are kept in the pulverizer 1′ for continuing jet mill crushing; in the classification device 2′, by classification process, the ultra fine powder enters the ultra fine powder collecting device 4′ via pipe, the finished powder enters the powder collecting device 3′ for subsequent process; in the ultra fine powder collecting device 4′, the gas and the ultra fine powder are separated, air outlet of the ultra fine powder device 4′ is connected to the compressor 5′ via pipe, the gas recycles via compressor 5′, the ultra fine powder is kept in the ultra fine powder collecting device 4′, it should be noted that, the ultra fine powder is powder with grain size smaller than 1 μm, the ultra fine powder collected by the ultra fine powder collecting device 4′ is discarded. Discard rate of ultra fine powder (%): calculating the powder weight of the ultra fine powder collecting device 4′, divided by the raw material weight, expressed as a percentage.

TABLE 6 is a magnetic property comparison TABLE between the embodiments and the comparing samples.

TABLE 6
magnetic property comparison TABLE

| | Discard | | | | | | Oxygen |
|---|---|---|---|---|---|---|---|
| | rate of | | | | | | Content of |
| | ultra fine | | | | (BH) | HAST | the Sintered |
| | powder | Br | Hcj | Hk/Hcj | max | weightlessness | magnet |
| No. | (%) | (kGs) | (k0e) | (%) | (MG0e) | (mg) | (ppm) |
| Embodiment 4 | 0 | 14.5 | 12.1 | 98.2 | 50.8 | 1.7 | 925 |
| Embodiment 5 | 0 | 13.7 | 15.3 | 98.1 | 46.0 | 1.6 | 940 |
| Embodiment 6 | 0 | 13.4 | 17.4 | 97.9 | 44.4 | 1.7 | 970 |
| Embodiment 7 | 0.8 | 14.4 | 11.2 | 85.5 | 49.4 | 30.2 | 898 |
| Comparing | 1.3 | 13.6 | 14.1 | 83.2 | 44.5 | 32.6 | 923 |
| sample 8 | | | | | | | |
| Comparing | 3.1 | 13.0 | 15.9 | 83.9 | 40.8 | 36.3 | 940 |
| sample 9 | | | | | | | |
| Comparing | 2.0 | 14.4 | 9.9 | 74.3 | 49.4 | 7.4 | 933 |
| sample 10 | | | | | | | |
| Comparing | 2.7 | 13.7 | 12.8 | 76.8 | 45.0 | 6.9 | 942 |
| sample 11 | | | | | | | |
| Comparing | 4.2 | 13.1 | 14.9 | 72.3 | 41.6 | 7.3 | 935 |
| sample 12 | | | | | | | |

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended

### INDUSTRIAL APPLICABILITY

The present invention is provided with manufacturing method of rare earth magnet alloy powder, rare earth magnet and a powder making device that ultra fine powder with grain size smaller than 1 μm is not separated from the crushed powder with low oxygen content from the pulverizer, the oxygen content in the pulverizer is reduced to below 1000 ppm when crushing, so that in the subsequent sintering process, abnormal grain growth (AGG) rarely happens in the sintered magnet with low oxygen content, it simplifies the processes and reduces manufacturing cost.

1. A manufacturing method of rare earth magnet alloy powder, the rare earth magnet comprises R₂T₁₄B main phase, R is at least one kind of rare earth elements comprising yttrium, T is at least one kind of transition metal elements comprising Fe and/or Co, wherein the method comprises a process of fine grinding at least one kind of rare earth magnet alloy or at least one kind of rare earth magnet alloy coarse powder in inert jet stream with oxygen content below 1000 ppm, to obtain powder that has grain size smaller than 50 μm, the powder comprises ultrafine powder with grain size smaller than 1 μm.

2. The manufacturing method of rare earth magnet alloy powder according to claim 1, wherein the rare earth magnet alloy comprises at least two kinds of rare earth magnet alloy with different rare earth components and/or contents.

3. The manufacturing method of rare earth magnet alloy powder according to claim 1, wherein the alloy coarse powder is obtained from alloy by using hydrogen decrepitation method.

4. The manufacturing method of rare earth magnet alloy powder according to claim 3, wherein the rare earth magnet alloy is obtained from alloy melt liquid by strip casted and cooled in a cooling speed between 10²° C./s and 10⁴° C./s.

5. The manufacturing method of rare earth magnet alloy powder according to claim 1, wherein the flow rate of the inert jet stream is 2˜50 m/s.

6. The manufacturing method of rare earth magnet alloy powder according to claim 5, wherein the normal temperature dew point of the inert jet stream is below −10° C. in 0.1 MPa˜1.0 MPa.

7. A manufacturing method of rare earth magnet, the rare earth magnet comprises R₂T₁₄B main phase, where R is at least one kind of rare earth elements comprising yttrium, T is at least one kind of transition metal elements comprising Fe and/or Co, wherein comprising following processes:
fine grinding at least one kind of rare earth magnet alloy or at least one kind of rare earth magnet alloy coarse powder in inert jet stream with oxygen content below 1000 ppm, to obtain powder that has grain size smaller than 50 μm comprising ultrafine powder with grain size smaller than 1 μm; and
a compact is produced by compacting the aforementioned powder;
sintering the green compacts to make rare earth magnet.

8. A powder making device of rare earth magnet alloy powder, comprising a pulverizer, a first collecting device, a charging bucket and a compressor, the pulverizer comprises a powder inlet, an air inlet at the lower portion and an air outlet at the upper portion, the air inlet of the pulverizer is connected to the compressor, the air outlet is disposed with a first filter for powder with grain size smaller than 50 μm; the first collecting device is disposed with an air inlet at the upper portion and an air outlet at the top portion, the air inlet is connected to the air outlet of the pulverizer by a pipe, the bottom of the first collecting device is connected to the charging bucket, wherein the air outlet of the first collecting device is extending downwardly with a second filter for gas-solid separation, and is connected to the compressor, the second filter is disposed corresponding to the air inlet of the first collecting device.

9. A powder making device of rare earth magnet alloy powder, comprising a pulverizer, a first collecting device, a charging bucket, a second collecting device and a compressor, the pulverizer comprises a powder inlet, an air inlet at the lower portion and an air outlet at the upper portion, the air inlet of the pulverizer is connected to the compressor, the air outlet is disposed with a filter for powder with grain size smaller than 50 μm; the first collecting device is disposed with an air inlet at the upper portion and an air outlet at the top portion, the air inlet is connected to the air outlet of the pulverizer via pipe, the bottom of the first collecting device is connected to the charging bucket, the second collecting device is ultra fine powder collecting device with an air inlet at the upper portion and an air outlet at the top portion, the air inlet is connected to the air outlet of the first collecting device via pipe, the air outlet is connected to the compressor, the ultra fine powder is powder with grain size smaller than 1 μm, wherein the second collecting device is disposed with a powder outlet at the bottom portion, the powder outlet is connected to the bottom portion of the first collecting device via a pipe with a valve.
